(19) United States
(12) Patent Application Publication
(10) Pub. No.: US 2023/0134615 A1
(43) Pub. Date: May 4, 2023

(54) METHOD OF PROCESSING TASK, ELECTRONIC DEVICE, AND STORAGE MEDIUM

(71) Applicant: Beijing Baidu Netcom Science Technology Co., Ltd., Beijing (CN)

(72) Inventors: Qunyi XIE, Beijing (CN); Dongdong ZHANG, Beijing (CN); Xiameng QIN, Beijing (CN); Mengyi EN, Beijing (CN); Yangliu XU, Beijing (CN); Yi CHEN, Beijing (CN); Ju HUANG, Beijing (CN); Kun YAO, Beijing (CN)

(21) Appl. No.: 18/146,839

(22) Filed: Dec. 27, 2022

(30) Foreign Application Priority Data
Jan. 28, 2022 (CN) 202210110164.4

(51) Int. Cl. G06F 9/48; G06F 40/205; G06F 9/50

(52) U.S. Cl. CPC G06F 9/4806; G06F 9/5005; G06F 40/205

(57) ABSTRACT

A method of processing a task, an electronic device, and a storage medium are provided, which relate to a field of artificial intelligence, in particular to fields of deep learning and computer vision, and may be applied to OCR optical character recognition and other scenarios. The method includes: parsing labeled data to be processed according to a task type identification, to obtain task labeled data, a tag information of the task labeled data is matched with the task type identification, and the task labeled data includes first task labeled data and second task labeled data; training a model using the first task labeled data, to obtain candidate models, the model is determined according to the task type identification; and determining a target model from the candidate models according to a performance evaluation result obtained by performing performance evaluation on the plurality of candidate models using the second task labeled data.

### CROSS-REFERENCE TO RELATED APPLICATION(S

This application claims the benefit of Chinese Patent Application No. 202210110164.4 filed on Jan. 28, 2022, the whole disclosure of which is incorporated herein by reference.

### TECHNICAL FIELD

The present disclosure relates to a field of an artificial intelligence technology, in particular to fields of deep learning and computer vision technologies, and may be applied to an OCR optical character recognition and other scenarios. Specifically, the present disclosure relates to a method of processing a task, an electronic device, and a storage medium.

### BACKGROUND

With a development of the artificial intelligence technology, deep learning is widely used in various service scenarios. The service scenarios of deep learning are variable, and there is a need to design deep learning models suitable for different service scenarios.

In order to obtain a deep learning model suitable for a service scenario, a data collection, a data labeling, a model training, a model testing, a model selection and other operations are involved.

### SUMMARY

The present disclosure provides a method of processing a task, an electronic device, and a storage medium.

According to an aspect of the present disclosure, a method of processing a task is provided, including: parsing, in response to receiving a task processing request, labeled data to be processed according to a task type identification indicated by the task processing request, so as to obtain task labeled data, wherein a tag information of the task labeled data is matched with the task type identification, and the task labeled data includes first task labeled data and second task labeled data; training a model to be trained by using the first task labeled data, so as to obtain a plurality of candidate models, wherein the model to be trained is determined according to the task type identification; and determining a target model from the plurality of candidate models according to a performance evaluation result, wherein the performance evaluation result is obtained by performing a performance evaluation on the plurality of candidate models using the second task labeled data.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method described in the present disclosure.

According to another aspect of the present disclosure, a non-transitory computer-readable storage medium having computer instructions therein is provided, and the computer instructions are configured to cause a computer to implement the method described in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a method and an apparatus of processing a task may be applied according to embodiments of the present disclosure;

FIG. 2 schematically shows a flowchart of a method of processing a task according to embodiments of the present disclosure;

FIG. 3 schematically shows a flowchart of parsing labeled data to be processed according to a task type identification indicated by a task processing request so as to obtain task labeled data according to embodiments of the present disclosure;

FIG. 4 schematically shows an exemplary schematic diagram of a task processing process according to embodiments of the present disclosure;

FIG. 5 schematically shows an example schematic diagram of adding a model structure to be added to a model structure library according to embodiments of the present disclosure;

FIG. 6 schematically shows an example schematic diagram of obtaining labeled data according to embodiments of the present disclosure;

FIG. 7 schematically shows a block diagram of an apparatus of processing a task according to embodiments of the present disclosure; and

FIG. 8 schematically shows a block diagram of an electronic device suitable for implementing a method of processing a task according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following descriptions.

For a model training and a model testing, different tasks require different model structures, and methods of training a model and testing a model may also be different. In addition, because the model testing and the model training are not synchronized, a model management is not unified, which causes a low efficiency of the model training and high time and labor costs.

In view of this, embodiments of the present disclosure propose a task processing solution. In response to receiving a task processing request, labeled data to be processed is parsed according to a task type identification indicated by the task processing request, so as to obtain task labeled data. A tag information of the task labeled data is matched with the task type identification, and the task labeled data includes first task labeled data and second task labeled data. A model to be trained is trained by using the first task labeled data, so as to obtain a plurality of candidate models. The model to be trained is determined according to the task type identification. A target model is determined from the plurality of candidate models according to a performance evaluation result obtained by performing a performance evaluation on the plurality of candidate models using the second task labeled data.

According to embodiments of the present disclosure, the model to be trained is determined according to the task type identification, that is, each model to be trained has a task type identification corresponding to the model, so that a unified management of models may be achieved. By training the model to be trained using the first task labeled data, a plurality of candidate models may be obtained, and a performance evaluation may be performed on the plurality of candidate models by using the second task labeled data, so that the model training and the model testing may be performed simultaneously, that is, training while testing is achieved, thereby improving the efficiency of the model training and reducing the time and labor costs.

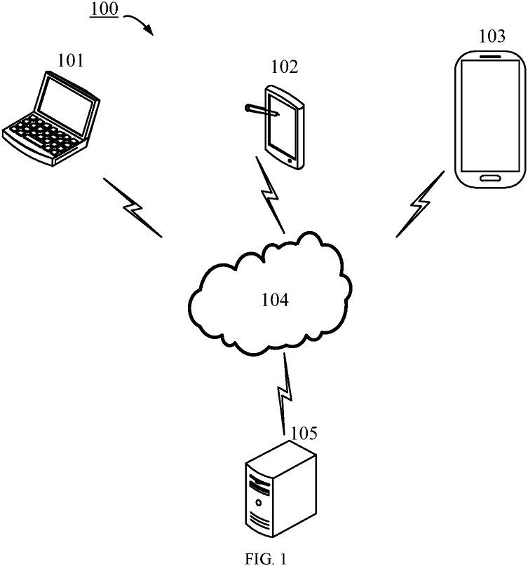

FIG. 1 schematically shows an exemplary system architecture to which a method and an apparatus of processing a task may be applied according to embodiments of the present disclosure.

It should be noted that FIG. 1 is merely an example of a system architecture to which embodiments of the present disclosure may be applied to help those skilled in the art understand the technical content of the present disclosure, but it does not mean that embodiments of the present disclosure may not be applied to other devices, systems, environments or scenarios. For example, in other embodiments, an exemplary system architecture to which a method and an apparatus of processing a task may be applied may include a terminal device, but the terminal device may implement the method and the apparatus of processing the task provided in embodiments of the present disclosure without interacting with a server..

As shown in FIG. 1, a system architecture 100 according to such embodiments may include terminal devices 101, 102 and 103, a network 104, and a server 105. The network 104 is used as a medium for providing a communication link between the terminal devices 101, 102, 103 and the server 105. The network 104 may include various connection types, such as wired and/or wireless communication links, and the like.

The terminal devices 101, 102 and 103 may be used by a user to interact with the server 105 through the network 104, so as to send or receive messages, etc. The terminal devices 101, 102 and 103 may be installed with various communication client applications, such as knowledge reading applications, web browser applications, search applications, instant messaging tools, mailbox clients and/or social platform software, etc. (for example only).

The terminal devices 101, 102 and 103 may be various electronic devices having display screens and supporting web browsing, including but not limited to smartphones, tablet computers, laptop computers, desktop computers, and so on.

The server 105 may be a server that provides various services, such as a background management server (for example only) that provides a support for a content browsed by the user using the terminal devices 101, 102 and 103. The background management server may analyze and process a received user request and other data, and feed back a processing result (for example, a webpage, information or data acquired or generated according to the user request) to the terminal devices.

The server 105 may be a cloud server, also known as a cloud computing server or a cloud host, which is a host product in a cloud computing service system to solve shortcomings of difficult management and weak service scalability existing in an existing physical host and VPS (Virtual Private Server) service. The server 105 may also be a server of a distributed system or a server combined with a block-chain. It should be noted that the method of processing the task provided by embodiments of the present disclosure may generally be performed by the server 105. Accordingly, the apparatus of processing the task provided by embodiments of the present disclosure may be generally provided in the server 105. The method of processing the task provided by embodiments of the present disclosure may also be performed by a server or server cluster different from the server 105 and capable of communicating with the terminal devices 101, 102, 103 and/or the server 105. Accordingly, the apparatus of processing the task provided by embodiments of the present disclosure may also be provided in a server or server cluster different from the server 105 and capable of communicating with the terminal devices 101, 102, 103 and/or the server 105.

Alternatively, the method of processing the task provided by embodiments of the present disclosure may generally be performed by the terminal device 101, 102 or 103. Accordingly, the apparatus of processing the task provided by embodiments of the present disclosure may also be provided in the terminal device 101, 102 or 103.

It should be understood that a number of terminal devices, network and server in FIG. 1 are merely schematic. According to the implementation needs, any number of terminal devices, networks and servers may be provided.

It should be noted that a sequence number of each operation in the following methods is merely used to represent the operation for ease of description, and should not be regarded as indicating an execution order of each operation. Unless explicitly stated, the methods do not need to be performed exactly in the order shown.

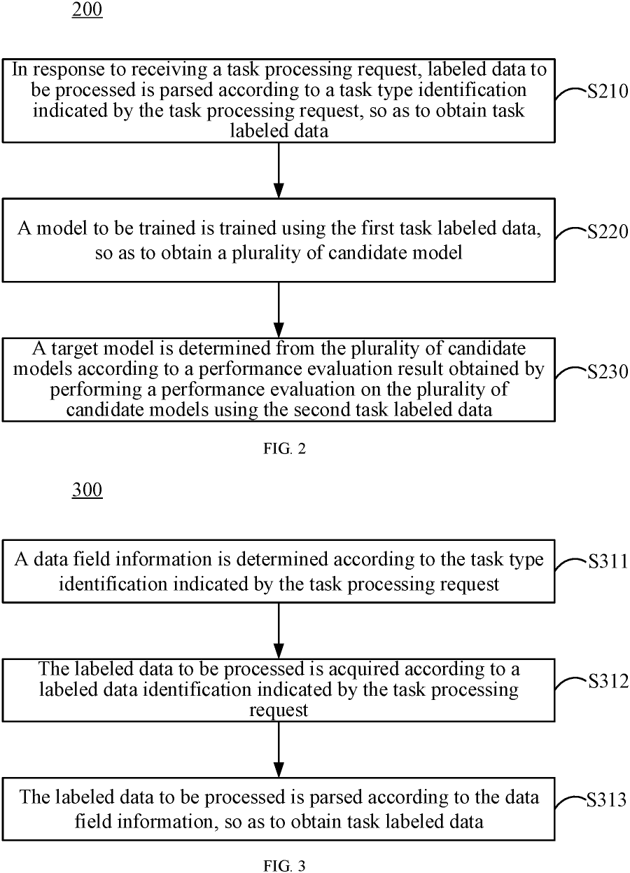

FIG. 2 schematically shows a flowchart of a method of processing a task according to embodiments of the present disclosure.

As shown in FIG. 2, a method 200 includes operation S210 to operation S230.

In operation S210, in response to receiving a task processing request, labeled data to be processed is parsed according to a task type identification indicated by the task processing request, so as to obtain task labeled data. A tag information of the task labeled data is matched with the task type identification. The task labeled data includes first task labeled data and second task labeled data.

In operation S220, a model to be trained is trained using the first task labeled data, so as to obtain a plurality of candidate models. The model to be trained is determined according to the task type identification.

In operation S230, a target model is determined from the plurality of candidate models according to a performance evaluation result obtained by performing a performance evaluation on the plurality of candidate models using the second task labeled data.

According to embodiments of the present disclosure, the task processing request may refer to a request for processing a task corresponding to a task type. The task type may be indicated by the task type identification. The task processing request may include the task type identification. The task may include a training task for the model to be trained and a testing task for the candidate model. The testing task for the candidate model may refer to a task of performing a performance evaluation on the candidate model.

According to embodiments of the present disclosure, the task type identification may include at least one selected from: an image processing task identification, a text processing task identification, or an audio processing task identification. The image processing task identification is used to represent an image processing task. The text processing task identification is used to represent a text processing task. The audio processing task identification is used to represent an audio processing task.

According to embodiments of the present disclosure, the image processing task identification may include at least one selected from: an image recognition task identification, an image segmentation task identification, or an object detection task identification. The image recognition task identification is used to represent an image recognition task. The image segmentation task identification is used to represent an image segmentation task. The object detection task identification is used to represent an object detection task.

According to embodiments of the present disclosure, the text processing task identification may include at least one selected from: a text recognition task identification, a text detection task identification, or a text translation task identification. The text recognition task identification is used to represent a text recognition task. The text detection task identification is used to represent a text detection task. The text translation task identification is used to represent a text translation task. The text detection task identification may include at least one selected from: an object classification task identification, a direction determination task identification, an object detection task identification, a field-level detection task identification, or a scene recognition task identification. The object classification task identification is used to represent an objection classification task. The direction determination task identification is used to represent a direction determination task. The object detection task identification is used to represent an object detection task. The field-level detection task identification is used to represent a field-level detection task. The scene recognition task identification is used to represent a scene recognition task.

According to embodiments of the present disclosure, the audio processing task identification may include at least one selected from: a speech recognition task identification, a speech translation task identification, or a speech synthesis task identification. The speech recognition task identification is used to represent a speech recognition task. The speech translation task identification is used to represent a speech translation task. The speech synthesis task identification is used to represent a speech synthesis task.

According to embodiments of the present disclosure, the candidate model may refer to a model trained from the model to be trained. The model to be trained may be a model corresponding to the task type represented by the task type identification. The model to be trained may include at least one selected from: an image processing model, a text processing model, or an audio processing model. The image processing model may include at least one selected from: an image recognition model, an image segmentation model, or an object detection model. The text processing model may include at least one selected from: a text recognition model, a text detection model, or a text translation model. The audio processing model may include at least one selected from: a speech recognition model, a speech translation model, or a speech synthesis model. The text detection model may include at least one selected from: an object classification module, a direction determination module, an object detection module, a field-level detection module, or a scene recognition module.

According to embodiments of the present disclosure, the labeled data may refer to task data containing a full amount of tag information. The labeled data to be processed may refer to labeled data corresponding to the task type represented by the task type identification. The task labeled data may refer to labeled data matched with the task type represented by the task type identification. The task labeled data may include the task data and the tag information of the task data.

According to embodiments of the present disclosure, the task labeled data may include first task labeled data and second task labeled data. The first task labeled data may be used to perform a model training task on the model to be trained. The second task labeled data may be used to perform a testing task on the candidate model, that is, the second task labeled data may be used to perform a performance evaluation on the candidate model. A ratio of the number of the first task labeled data to the number of the second task labeled data in the task labeled data may be configured according to actual service requirements, which is not limited here. For example, the ratio of numbers is 7:3.

According to embodiments of the present disclosure, in response to receiving a task processing request, the task processing request may be parsed to obtain a task type identification. A task type may be determined according to the task type identification indicated by the task processing request, and the labeled data to be processed may be determined according to the task type. The labeled data to be processed may be parsed according to the task type, so as to obtain the task labeled data.

According to embodiments of the present disclosure, after the task labeled data is obtained, in a case of the same model to be trained, the model to be trained may be trained for each hyper-parameter information in a plurality of hyper-parameter information by using the first task labeled data in a case of the hyper-parameter information, so as to obtain a candidate model corresponding to the hyper-parameter information. In this way, candidate models respectively corresponding to the plurality of hyper-parameter information may be obtained. The hyper-parameter information may include at least one selected from: a number of training times, a learning rate, a number of hidden layers of a neural network model, or a number of neurons in each layer of the neural network model.

According to embodiments of the present disclosure, after the plurality of candidate models are obtained, a performance evaluation may be performed on each of the plurality of candidate models based on a performance evaluation index by using the second task labeled data, so as to obtain respective performance evaluation results of the plurality of candidate models. The performance evaluation index may refer to an index for evaluating a model performance of the candidate model. The performance evaluation index may include at least one selected from: an accuracy rate (i.e., Accuracy), a precision rate (i.e., Precision), a recall rate (i.e., Recall), a harmonic mean of precision rate and recall rate (i.e., F1), sensitivity, a confusion matrix, or an ROC (Receiver Operating Characteristic) curve.

According to embodiments of the present disclosure, a target model may be determined from the plurality of candidate models according to the respective performance evaluation results of the plurality of candidate models. The target model may refer to a model of which the performance evaluation result meets a predetermined condition.

According to embodiments of the present disclosure, the model to be trained is determined according to the task type identification, that is, each model to be trained has a task type identification corresponding to the model, so that a unified management of models may be achieved. A plurality of candidate models may be obtained by training the model to be trained using the first task labeled data, and then a performance evaluation may be performed on the plurality of candidate models using the second task labeled data, so that the model training and the model testing may be performed simultaneously, that is, training while testing is achieved, thereby improving the efficiency of the model training and reducing the time and labor costs.

The method of processing the task according to embodiments of the present disclosure will be further described with reference to FIG. 3 to FIG. 6 in combination with specific embodiments.

FIG. 3 schematically shows a flowchart of parsing the labeled data to be processed according to the task type identification indicated by the task processing request so as to obtain the task labeled data according to embodiments of the present disclosure.

As shown in FIG. 3, a method 300 includes operation S311 to operation S313.

In operation S311, a data field information is determined according to the task type identification indicated by the task processing request.

In operation S312, the labeled data to be processed is acquired according to a labeled data identification indicated by the task processing request.

In operation S313, the labeled data to be processed is parsed according to the data field information, so as to obtain task labeled data.

According to embodiments of the present disclosure, the task processing request may include a task type identification and a labeled data identification. The labeled data identification may be used to represent labeled data containing a full amount of tag information and required to participate in the task. The data field information may refer to a tag field information corresponding to the task type represented by the task type identification.

According to embodiments of the present disclosure, in response to receiving a task processing request, the task processing request may be parsed to obtain a task type identification and a labeled data identification. Then, a data field information matched with the task type represented by the task type identification may be determined according to the task type identification. The labeled data to be processed that is required to participate in the task indicated by the task type may be determined according to the labeled data identification. Finally, the labeled data to be processed is parsed according to the data field information, so as to obtain task labeled data matched with the task type represented by the task type identification.

For example, the task type identification may be an object classification task identification. The labeled data identification may be a labeled data identification related to a text detection. Thus, the data field information is an object classification field information. The labeled data to be processed may be parsed based on the object classification field information, so as to obtain task labeled data corresponding to the object classification task.

According to embodiments of the present disclosure, operation S313 may include the following operations.

A parsing tool is invoked. The labeled data to be processed is parsed based on the data field information by using the parsing tool, so as to obtain task labeled data.

According to embodiments of the present disclosure, the parsing tool may refer to a tool for parsing the labeled data to be processed. The parsing tool may include a routine related to parsing the labeled data to be processed. The parsing tool may be invoked in response to receiving a task processing request. The labeled data to be processed may be parsed based on the data field information by using the parsing tool, so as to obtain the task labeled data.

According to embodiments of the present disclosure, the method of processing the task may further include the following operations.

A model configuration information is determined according to the task processing request. A standard task model is determined according to the task type identification. The standard task model includes a plurality of standard model structures. At least one target model structure is determined from the plurality of standard model structures according to the model configuration information, so as to obtain a model to be trained.

According to embodiments of the present disclosure, the model configuration information may refer to a configuration information corresponding to a model to be trained that participates in the task. The model configuration information may include at least one selected from: a number of standard model structures, or a model structure function information. The model configuration information may further include a configuration information related to a loss function.

According to embodiments of the present disclosure, the standard task model may refer to a model including a full standard model structure and related to a task. The standard model structure may refer to a model structure with which a basic function may be achieved. The standard model structure may include at least one model sub-structure and a connection relationship between different model sub-structures. The standard model structure may be a structure obtained by connecting at least one model sub-structure based on the connection relationship between different model sub-structures. The at least one model sub-structure included in the standard model structure may be a structure from at least one operation layer, that is, the standard model structure may be a structure obtained by connecting at least one model sub-structure from at least one operation layer based on the connection relationship between different model sub-structures. For example, the at least one operation layer may include at least one selected from: an input layer, a convolution layer, a pooling layer, a fully connected layer, a batch normalization layer, a nonlinear layer, or the like. The at least one model sub-structure may include at least one selected from: a convolution structure (i.e., a convolution kernel), a pooling structure (i.e., a pooling kernel), a fully connected structure, a normalization structure, or the like. Different model sub-structures may have the same or different hyper-parameters. The hyper-parameter of the model sub-structure may include at least one selected from: a size of the model sub-structure, a number of model substructure, a stride, or the like. For example, the hyper-parameter of the convolution structure may include at least one selected from: a size of the convolution structure, a number of convolution structure, a convolution stride, or the like. The connection relationship may include an addition, a channel merging, and so on.

According to embodiments of the present disclosure, in response to receiving a task processing request, the task processing request may be parsed to obtain a model configuration information and a task type identification. Then, a standard task model corresponding to the task type identification and including a plurality of standard model structures is determined according to the task type identification. At least one target model structure matched with the number of standard model structures and the model structure function information included in the model configuration information may be determined from the plurality of standard model structures. Finally, the model to be trained may be obtained according to the at least one target model structure. For example, the at least one target model structure may be determined as the model to be trained.

According to embodiments of the present disclosure, at least one target model structure may be determined from a plurality of standard model structures based on the model configuration information, and the model configuration information may be configured according to actual service requirements, so that a flexible configuration of the model structure may be achieved, and a flexibility of the model training may be improved.

According to embodiments of the present disclosure, the method of processing the task may further include the following operations.

In response to receiving a model structure addition request, a model structure to be added is determined. The model structure to be added is added to a model structure library, so that a model training is performed by using the model structure to be added.

According to embodiments of the present disclosure, the model structure addition request may refer to a request for adding a model structure to the model structure library. The model structure addition request may be generated according to an identification of the model structure to be added corresponding to the model structure to be added. The model structure to be added may be obtained in response to detecting that the model structure addition operation is triggered. For example, the model structure to be added may be obtained in response to detecting that a determination control for the model structure to be added is triggered. The model structure library may include model structures for different tasks.

According to embodiments of the present disclosure, an upload of a model to be added to the model structure library by a user may be supported. A model structure may be automatically matched and retrieved based on the model configuration information, so that the flexibility of the model training may be improved.

According to embodiments of the present disclosure, the method of processing the task may further include the following operations.

In response to receiving a data labeling request, data to be labeled may be determined. The data to be labeled is labeled based on a predetermined data format by using a pre-labeling model, so as to obtain pre-labeled data. A tag information of the pre-labeled data is adjusted to obtain labeled data.

According to embodiments of the present disclosure, the data labeling request may refer to a request for labeling the data to be labeled. The data to be labeled may refer to data that a data labeling needs to be performed on. The predetermined data format may refer to a data format set to meet actual requirements. For example, the predetermined data format may include JOSN (JavaScript Object Notation). The pre-labeling model may be used to perform a pre-labeling on the model to be labeled.

According to embodiments of the present disclosure, in response to receiving the data labeling request, the data labeling request may be parsed to obtain the data to be labeled. Then, the data to be labeled may be labeled according to a predetermined data format by using the pre-labeling model, so as to obtain pre-labeled data. The pre-labeled data may include a tag information. Finally, the tag information of the pre-labeled data may be adjusted based on service requirements, so as to obtain labeled data.

According to embodiments of the present disclosure, the labeled data is obtained by adjusting the tag information of the pre-labeled data that is obtained by labeling the data to be labeled based on the predetermined data format using the pre-labeling model, so that an automatic generation of the labeled data and a unification of the data format may be achieved, a time consumption for data labeling may be reduced, and the efficiency of the model training may be improved.

According to embodiments of the present disclosure, the method of processing the task may further include the following operations.

A data labeling request is generated in response to detecting that a data labeling operation is triggered.

According to embodiments of the present disclosure, the data labeling operation may include an operation of a selection control or an input control for the data to be labeled.

According to embodiments of the present disclosure, the method of processing the task may further include the following operations.

The labeled data is stored to a data warehouse.

According to embodiments of the present disclosure, the labeled data may include data and a tag information corresponding to the data. The data warehouse may not only be used to store data in various data formats, but also may be used to store the tag information corresponding to the data.

According to embodiments of the present disclosure, the data to be labeled may be acquired from the data warehouse, and after the data to be labeled is labeled, the labeled data may be stored in the data warehouse.

According to embodiments of the present disclosure, the method of processing the task may further include the following operations.

A data processing strategy corresponding to a task type identification is determined in response to receiving a task processing request. The labeled data is processed by using the data processing strategy, so as to obtain labeled data corresponding to the task type identification. The labeled data corresponding to the task type identification includes labeled data to be processed.

According to embodiments of the present disclosure, the data processing strategy may refer to a strategy for processing the labeled data. The data processing strategy may include a content of how to obtain the labeled data corresponding to the task type identification. For example, the data processing strategy may include at least one selected from: a data merging strategy and a data splitting strategy. The data merging strategy may refer to a strategy for data merging of different labeled data. The data splitting strategy may refer to a strategy for splitting the labeled data.

According to embodiments of the present disclosure, a task processing request may be parsed in response to the task processing request being received, so as to obtain the task type identification. A data processing strategy corresponding to the task type identification may be determined. Then the labeled data may be processed using the data processing strategy, so as to obtain the labeled data corresponding to the task.

For example, the task processing request may be a request for an image recognition task. A plurality of labeled data related to the image recognition task may be acquired. It may be determined that the data processing strategy for the plurality of labeled data is a data merging strategy. A data merging may be performed on the plurality of labeled data based on the data merging strategy, so as to obtain the labeled data corresponding to the image recognition task.

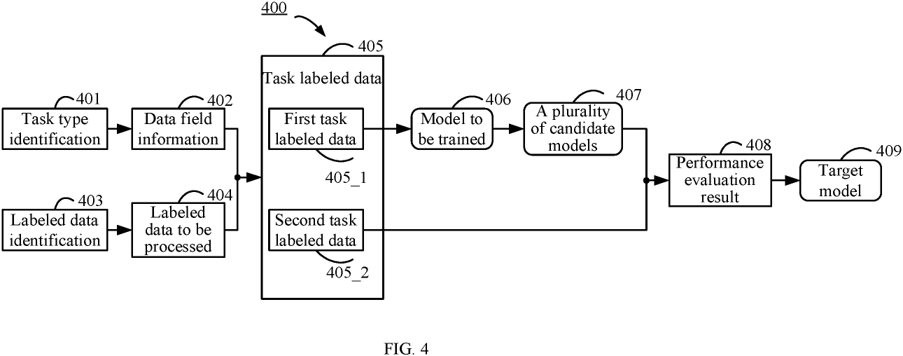

FIG. 4 schematically shows an exemplary schematic diagram of a process of processing a task according to embodiments of the present disclosure.

As shown in FIG. 4, in 400, a data field information 402 is determined according to a task type identification 401 indicated by a task processing request. Labeled data to be processed 404 is acquired according to labeled data identification 403 indicated by the task processing request. The labeled data to be processed 404 is parsed according to the data field information 402, so as to obtain task labeled data 405. The task labeled data 405 may include first task labeled data 405_1 and second task labeled data 405_2.

A model to be trained 406 is trained by using the first task labeled data 405_1, so as to obtain a plurality of candidate models 407. A performance evaluation is performed on the plurality of candidate models 407 by using the second task labeled data 405_2, so as to obtain a performance evaluation result 408. A target model 409 is determined from the plurality of candidate models 407 based on the performance evaluation result 408.

FIG. 5 schematically shows an example schematic diagram of adding a model structure to be added to a model structure library according to embodiments of the present disclosure.

As shown in FIG. 5, in 500, a model structure to be added 502 is determined on a display interface 501, and a model structure addition operation is triggered by clicking a model addition control 503. The model structure to be added 502 is added to a model structure library 504 in response to detecting that the model structure addition operation is triggered, so as to perform a model training by using the model structure to be added 502.

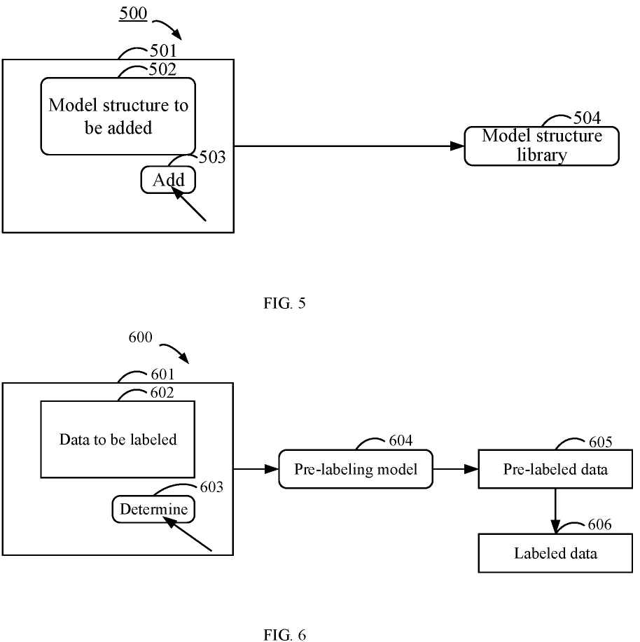

FIG. 6 schematically shows an example schematic diagram of obtaining labeled data according to embodiments of the present disclosure.

As shown in FIG. 6, in 600, data to be labeled 602 is determined on a display interface 601, and a data labeling operation is triggered by clicking a confirmation control 603 for data labeling. In response to detecting that the data labeling operation is triggered, the data to be labeled is labeled based on a predetermined data format by using a pre-labeling model 604, so as to obtain pre-labeled data 605. A tag information of the pre-labeled data 605 is adjusted to obtain labeled data 606.

The above are only exemplary embodiments. The present disclosure is not limited thereto, and may further include other methods of processing a task known in the art, as long as the task processing may be performed.

It should be noted that in the technical solution of the present disclosure, an acquisition, a storage, a use, a processing, a transmission, a provision, a disclosure and an application of user personal information involved comply with provisions of relevant laws and regulations, take essential confidentiality measures, and do not violate public order and good custom. In the technical solution of the present disclosure, authorization or consent is obtained from the user before the user’s personal information is obtained or collected.

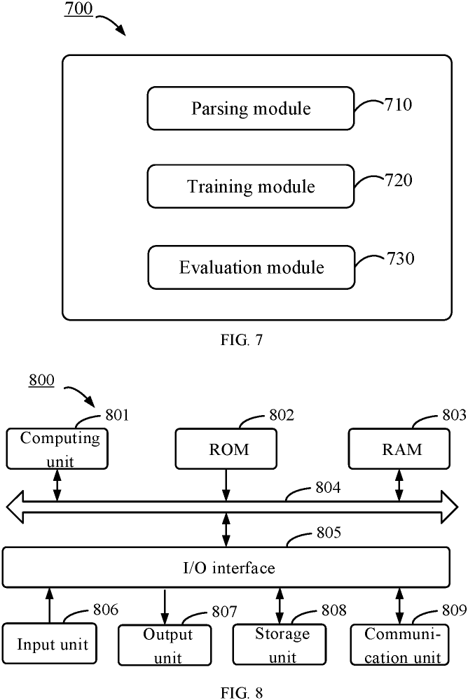

FIG. 7 schematically shows a block diagram of an apparatus of processing a task according to embodiments of the present disclosure.

As shown in FIG. 7, an apparatus 700 of processing a task may include a parsing module 710, a training module 720, and an evaluation module 730.

The parsing module 710 may be used to parse, in response to receiving a task processing request, labeled data to be processed according to a task type identification indicated by the task processing request, so as to obtain task labeled data. A tag information of the task labeled data is matched with the task type identification, and the task labeled data includes first task labeled data and second task labeled data.

The training module 720 may be used to train a model to be trained by using the first task labeled data, so as to obtain a plurality of candidate models. The model to be trained is determined according to the task type identification.

The evaluation module 730 may be used to determine a target model from the plurality of candidate models according to a performance evaluation result. The performance evaluation result is obtained by performing a performance evaluation on the plurality of candidate models using the second task labeled data.

According to embodiments of the present disclosure, the parsing module 710 may include a determination sub-module, an acquisition sub-module, and a parsing sub-module.

The determination sub-module may be used to determine a data field information according to the task type identification indicated by the task processing request.

The acquisition sub-module may be used to acquire the labeled data to be processed according to a labeled data identification indicated by the task processing request.

The parsing sub-module may be used to parse the labeled data to be processed according to the data field information, so as to obtain the task labeled data.

According to embodiments of the present disclosure, the parsing sub-module may include an invoking unit and a parsing unit.

The invoking unit may be used to invoke a parsing tool.

The parsing unit may be used to parse, by using the parsing tool, the labeled data to be processed based on the data field information, so as to obtain the task labeled data.

According to embodiments of the present disclosure, an apparatus 700 of processing the task may further include a first determination module, a second determination module, and a third determination module.

The first determination module may be used to determine a model configuration information according to the task processing request.

The second determination module may be used to determine a standard task model according to the task type identification. The standard task model includes a plurality of standard model structures.

The third determination module may be used to determine at least one target model structure from the plurality of standard model structures according to the model configuration information, so as to obtain the model to be trained.

According to embodiments of the present disclosure, an apparatus 700 of processing the task may further include a fourth determination module and an addition module.

The fourth determination module may be used to determine a model structure to be added, in response to receiving a model structure addition request.

The addition module may be used to add the model structure to be added to a model structure library, so as to perform a model training by using the model structure to be added.

According to embodiments of the present disclosure, an apparatus 700 of processing the task may further include a fifth determination module, a labeling module, and an adjustment module.

The fifth determination module may be used to determine data to be labeled, in response to receiving a data labeling request.

The labeling module may be used to label, by using a pre-labeling model, the data to be labeled based on a predetermined data format, so as to obtain pre-labeled data.

The adjustment module may be used to adjust a tag information of the pre-labeled data, so as to obtain labeled data.

According to embodiments of the present disclosure, an apparatus 700 of processing the task may further include a generation module.

The generation module may be used to generate the data labeling request in response to a detection that a data labeling operation is triggered.

According to embodiments of the present disclosure, an apparatus 700 of processing the task may further include a storage module.

The storage module may be used to store the labeled data in a data warehouse.

According to embodiments of the present disclosure, an apparatus 700 of processing the task may further include a sixth determination module and an obtaining module.

The sixth determination module may be used to determine a data processing strategy corresponding to the task type identification, in response to receiving the task processing request.

The obtaining module may be used to process the labeled data by using the data processing strategy, so as to obtain labeled data corresponding to the task type identification. The labeled data corresponding to the task type identification includes the labeled data to be processed.

According to embodiments of the present disclosure, the present disclosure further provides an electronic device, a readable storage medium, and a computer program product.

According to embodiments of the present disclosure, the present disclosure further provides an electronic device, including: at least one processor; and a memory communicatively connected to the at least one processor, the memory stores instructions executable by the at least one processor, and the instructions, when executed by the at least one processor, cause the at least one processor to implement the method described above.

According to embodiments of the present disclosure, the present disclosure further provides a non-transitory computer-readable storage medium having computer instructions therein, and the computer instructions are used to cause a computer to implement the method described above.

According to embodiments of the present disclosure, the present disclosure further provides a computer program product containing a computer program, and the computer program, when executed by a processor, causes the processor to implement the method described above.

FIG. 8 schematically shows a block diagram of an electronic device for implementing the method of processing the task according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, an electronic device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and steps described above, such as the method of processing the task. For example, in some embodiments, the method of processing the task may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method of processing the task described above. Alternatively, in other embodiments, the computing unit 801 may be used to perform the method of processing the task by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing a task, comprising:
parsing, in response to receiving a task processing request, labeled data to be processed according to a task type identification indicated by the task processing request, so as to obtain task labeled data, wherein a tag information of the task labeled data is matched with the task type identification, and the task labeled data comprises first task labeled data and second task labeled data;
training a model to be trained by using the first task labeled data, so as to obtain a plurality of candidate models, wherein the model to be trained is determined according to the task type identification; and
determining a target model from the plurality of candidate models according to a performance evaluation result, wherein the performance evaluation result is obtained by performing a performance evaluation on the plurality of candidate models using the second task labeled data.

2. The method according to claim 1, wherein the parsing labeled data to be processed according to a task type identification indicated by the task processing request, so as to obtain task labeled data comprises:
determining a data field information according to the task type identification indicated by the task processing request;
acquiring the labeled data to be processed according to a labeled data identification indicated by the task processing request; and
parsing the labeled data to be processed according to the data field information, so as to obtain the task labeled data.

3. The method according to claim 2, wherein the parsing the labeled data to be processed according to the data field information, so as to obtain the task labeled data comprises:
invoking a parsing tool; and
parsing, by using the parsing tool, the labeled data to be processed based on the data field information, so as to obtain the task labeled data.

4. The method according to claim 1, further comprising:
determining a model configuration information according to the task processing request;
determining a standard task model according to the task type identification, wherein the standard task model comprises a plurality of standard model structures; and
determining at least one target model structure from the plurality of standard model structures according to the model configuration information, so as to obtain the model to be trained.

5. The method according to claim 1, further comprising:
determining a model structure to be added, in response to receiving a model structure addition request; and
adding the model structure to be added to a model structure library, so as to perform a model training by using the model structure to be added.

6. The method according to claim 1, further comprising:
determining data to be labeled, in response to receiving a data labeling request;
labeling, by using a pre-labeling model, the data to be labeled based on a predetermined data format, so as to obtain pre-labeled data; and
adjusting a tag information of the pre-labeled data, so as to obtain labeled data.

7. The method according to claim 6, further comprising:
generating the data labeling request in response to a detection that a data labeling operation is triggered.

8. The method according to claim 6, further comprising:
storing the labeled data in a data warehouse.

9. The method according to claim 6, further comprising:
determining a data processing strategy corresponding to the task type identification, in response to receiving the task processing request; and
processing the labeled data by using the data processing strategy, so as to obtain labeled data corresponding to the task type identification, wherein the labeled data corresponding to the task type identification comprises the labeled data to be processed.

10. An electronic device, comprising:
at least one processor; and
a memory communicatively connected to the at least one processor, wherein the memory stores instructions executable by the at least one processor, and the instructions, when executed by the at least one processor, cause the at least one processor to:
parse, in response to receiving a task processing request, labeled data to be processed according to a task type identification indicated by the task processing request, so as to obtain task labeled data, wherein a tag information of the task labeled data is matched with the task type identification, and the task labeled data comprises first task labeled data and second task labeled data;
train a model to be trained by using the first task labeled data, so as to obtain a plurality of candidate models, wherein the model to be trained is determined according to the task type identification; and
determine a target model from the plurality of candidate models according to a performance evaluation result, wherein the performance evaluation result is obtained by performing a performance evaluation on the plurality of candidate models using the second task labeled data.

11. The electronic device according to claim 10, wherein the at least one processor is further configured to:
determine a data field information according to the task type identification indicated by the task processing request;
acquire the labeled data to be processed according to a labeled data identification indicated by the task processing request; and
parse the labeled data to be processed according to the data field information, so as to obtain the task labeled data.

12. The electronic device according to claim 11, wherein the at least one processor is further configured to:
invoke a parsing tool; and
parse, by using the parsing tool, the labeled data to be processed based on the data field information, so as to obtain the task labeled data.

13. The electronic device according to claim 10, wherein the at least one processor is further configured to:
determine a model configuration information according to the task processing request;
determine a standard task model according to the task type identification, wherein the standard task model comprises a plurality of standard model structures; and
determine at least one target model structure from the plurality of standard model structures according to the model configuration information, so as to obtain the model to be trained.

14. The electronic device according to claim 10, wherein the at least one processor is further configured to:
determine a model structure to be added, in response to receiving a model structure addition request; and
add the model structure to be added to a model structure library, so as to perform a model training by using the model structure to be added.

15. The electronic device according to claim 10, wherein the at least one processor is further configured to:
determine data to be labeled, in response to receiving a data labeling request;
label, by using a pre-labeling model, the data to be labeled based on a predetermined data format, so as to obtain pre-labeled data; and
adjust a tag information of the pre-labeled data, so as to obtain labeled data.

16. The electronic device according to claim 15, wherein the at least one processor is further configured to:
generate the data labeling request in response to a detection that a data labeling operation is triggered.

17. The electronic device according to claim 15, wherein the at least one processor is further configured to:
store the labeled data in a data warehouse.

18. The electronic device according to claim 15, wherein the at least one processor is further configured to:
determine a data processing strategy corresponding to the task type identification, in response to receiving the task processing request; and
process the labeled data by using the data processing strategy, so as to obtain labeled data corresponding to the task type identification, wherein the labeled data corresponding to the task type identification comprises the labeled data to be processed.

19. A non-transitory computer-readable storage medium having computer instructions therein, wherein the computer instructions are configured to cause a computer to:
parse, in response to receiving a task processing request, labeled data to be processed according to a task type identification indicated by the task processing request, so as to obtain task labeled data, wherein a tag information of the task labeled data is matched with the task type identification, and the task labeled data comprises first task labeled data and second task labeled data;
train a model to be trained by using the first task labeled data, so as to obtain a plurality of candidate models, wherein the model to be trained is determined according to the task type identification; and
determine a target model from the plurality of candidate models according to a performance evaluation result, wherein the performance evaluation result is obtained by performing a performance evaluation on the plurality of candidate models using the second task labeled data.

20. The non-transitory computer-readable storage medium according to claim 19, wherein the computer instructions are further configured to cause the computer to:
determine a data field information according to the task type identification indicated by the task processing request;
acquire the labeled data to be processed according to a labeled data identification indicated by the task processing request; and
parse the labeled data to be processed according to the data field information, so as to obtain the task labeled data.
